(19) United States
(12) Patent Application Publication
(10) Pub. No.: US 2025/0280205 A1
(43) Pub. Date: Sep. 4, 2025

(54) IMAGE PROCESSING APPARATUS AND IMAGE PROCESSING METHOD

(71) Applicant: CANON KABUSHIKI KAISHA, Tokyo (JP)

(72) Inventor: HIROAKI NASHIZAWA, Tokyo (JP)

(21) Appl. No.: 19/053,779

(22) Filed: Feb. 14, 2025

(30) Foreign Application Priority Data
Feb. 29, 2024 (JP) 2024-030636

(51) Int. Cl. H04N 25/57; H04N 23/83; H04N 23/86

(52) U.S. Cl. CPC H04N 25/57; H04N 23/83; H04N 23/86

(57) ABSTRACT

An image processing apparatus that handles a hybrid log gamma (HLG) image having been converted from a perceptual quantization (PQ) image is disclosed. The HLG image is a high-dynamic range (HDR) signal conforming to an HLG scheme and the PQ image is an HDR signal conforming to a PQ scheme. The apparatus obtains the HLG image and a parameter that is defined based on information related to a maximum luminance of the PQ image and converts a value of the parameter into a value conforming to the HLG scheme. The apparatus executes alert processing related to the HLG image with use of the converted value of the parameter.

### BACKGROUND

### Technical Field

The aspect of the embodiments relates to an image processing apparatus and an image processing method, and in particular to an image processing apparatus and an image processing method that use high dynamic range (HDR) signals.

### Description of the Related Art

A hybrid log gamma (HLG) scheme and a perceptual quantization (PQ) scheme have been standardized in relation to video signals that support a wider dynamic range than conventional video signals do. The HLG scheme defines the opto-electronic transfer function (OETF) indicating the relationship between display luminance and a video signal level, that is to say, the characteristics of an image capturing apparatus. On the other hand, the PQ scheme defines the electro-optical transfer function (EOTF) indicating the relationship between a video signal level and display luminance, that is to say, the characteristics of a display apparatus. In addition, in contrast to the HLG scheme that handles luminance as a relative value, the PQ scheme handles luminance as an absolute value.

It is disclosed in Japanese Patent Laid-Open No. 2021-90109 that the maximum luminance value [nits or cd/m²] of an output dynamic range, or a tone value (signal level) corresponding to the maximum luminance value, is recorded as a parameter maxDRL in association with HDR signals of the PQ scheme. By using maxDRL, the luminance of HDR signals of the PQ scheme can be appropriately mapped to the luminance of HDR signals of the HLG scheme or SDR signals.

HDR signals of the PQ scheme can be converted into HDR signals of the HLG scheme by using a method described in Report ITU-R BT.2408-5, “Guidance for operational practices in HDR television production”, [online], March 2022, ITU-R, [retrieved Dec. 26, 1992], Internet <https://www.itu.int/dms_pub/itu-r/opb/rep/R-REP-BT.24Aug. 5, 2022-PDF-E.pdf> (hereinafter, reference document 1). However, maxDRL that was recorded for HDR signals of the PQ scheme cannot be applied to HDR signals of the HLG scheme being converted from the HDR signals of the PQ scheme. Therefore, for the HDR signals converted from the PQ scheme into the HDR scheme, it is difficult to appropriately apply processing depending on luminance (e.g., highlight alert and the like) based on the luminance information such as the maxDRL that was recorded for the HDR signals before conversion.

### SUMMARY

According to an aspect of the present invention, there is provided an image processing apparatus that comprises one or more processors, wherein the one or more processors execute a program stored in a memory and thereby perform a method comprising: obtaining a hybrid log gamma (HLG) image having been converted from a perceptual quantization (PQ) image, wherein the HLG image is a high-dynamic range (HDR) signal conforming to an HLG scheme and the PQ image is an HDR signal conforming to a PQ scheme; obtaining a parameter that is defined based on information related to a maximum luminance of the PQ image; converting a value of the parameter into a value conforming to the HLG scheme; and executing alert processing related to the HLG image with use of the converted value of the parameter.

According to another aspect of the present invention, there is provided an image processing apparatus that comprises one or more processors, wherein the one or more processors execute a program stored in a memory and thereby perform a method comprising: converting a perceptual quantization (PQ) image into a hybrid log gamma (HLG) image, wherein the PQ image is an HDR signal conforming to a PQ scheme and the HLG image is a high-dynamic range (HDR) signal conforming to an HLG scheme; converting a parameter that is defined based on information related to a maximum luminance of the PQ image into a value conforming to the HLG scheme; and recording the HLG image and the converted value of the parameter in association with each other.

According to a further aspect of the present invention, there is provided an image processing method, comprising: obtaining a hybrid log gamma (HLG) image having been converted from a perceptual quantization (PQ) image, wherein the HLG image is a high-dynamic range (HDR) signal conforming to an HLG scheme and the PQ image is an HDR signal conforming to a PQ scheme; obtaining a parameter that is defined based on information related to a maximum luminance of the PQ image; converting a value of the parameter into a value conforming to the HLG scheme; and executing alert processing related to the HLG image with use of the converted value of the parameter.

According to another aspect of the present invention, there is provided an image processing method, comprising: converting a perceptual quantization (PQ) image into a hybrid log gamma (HLG) image, wherein the PQ image is an HDR signal conforming to a PQ scheme and the HLG image is a high-dynamic range (HDR) signal conforming to an HLG scheme; converting a parameter that is defined based on information related to a maximum luminance of the PQ image into a value conforming to the HLG scheme; and recording the HLG image and the converted value of the parameter in association with each other.

According to a further aspect of the present invention, there is provided a non-transitory computer-readable medium storing a program for causing a computer to perform an image processing method, comprising: obtaining a hybrid log gamma (HLG) image having been converted from a perceptual quantization (PQ) image, wherein the HLG image is a high-dynamic range (HDR) signal conforming to an HLG scheme and the PQ image is an HDR signal conforming to a PQ scheme; obtaining a parameter that is defined based on information related to a maximum luminance of the PQ image; converting a value of the parameter into a value conforming to the HLG scheme; and executing alert processing related to the HLG image with use of the converted value of the parameter.

According to another aspect of the present invention, there is provided a non-transitory computer-readable medium storing a program for causing a computer to perform an image processing method, comprising: converting a perceptual quantization (PQ) image into a hybrid log gamma (HLG) image, wherein the PQ image is an HDR signal conforming to a PQ scheme and the HLG image is a high-dynamic range (HDR) signal conforming to an HLG scheme; converting a parameter that is defined based on information related to a maximum luminance of the PQ image into a value conforming to the HLG scheme; and recording the HLG image and the converted value of the parameter in association with each other.

Further features of the disclosure will become apparent from the following description of exemplary embodiments (with reference to the attached drawings).

### BRIEF DESCRIPTION OF THE DRAWINGS

FIG. 1 is a block diagram showing an exemplary configuration of an image processing apparatus according to embodiments.

FIG. 2 is a diagram showing a model of conversion from a PQ scheme to an HLG scheme.

FIG. 3 is a flowchart showing an example of image processing pertaining to embodiments.

FIGS. 4A and 4B are diagrams showing the EOTF characteristics according to the ITU-R BT.2100 (PQ) standard, and the OETF characteristics according to the ITU-R BT.2100 (HLG) standard.

FIG. 5 is a diagram showing another model of conversion from a PQ scheme to an HLG scheme.

FIGS. 6A and 6B are diagrams showing an example of a data file structure used in the first embodiment.

FIG. 7 is a flowchart related to highlight alert processing according to a first embodiment.

FIGS. 8A and 8B are diagrams schematically showing the advantageous effects of the first embodiment.

FIGS. 9A and 9B are flowcharts related to LUT generation processing and highlight alert processing according to a second embodiment.

FIG. 10 is a diagram showing an example of a LUT used in the second embodiment.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

Note that the following embodiments will be described in relation to a case where the disclosure is embodied on a computer device (a personal computer, a tablet computer, a media player, a PDA, or the like) as one example of an image processing apparatus. However, the disclosure can be embodied on any electronic devices capable of handling HDR signals. These electronic devices include an image capturing apparatus, a smartphone, a game device, a display apparatus, a robot, a drone, and a driving recorder. These are examples, and the disclosure can be embodied on other electronic devices as well.

### First Embodiment

The disclosure can be applied to image data composed of data of pixels including a plurality of color components. For example, the image data may be image data generated by an image capturing apparatus that uses an image sensor including color filters. Note that HDR signals of the PQ scheme require a depth of 10 bits or more per component. Therefore, a data format that supports a depth of 10 bits or more is used.

It is assumed here that a data format conforming to the High Efficiency Image File Format (HEIF) standardized by ISO/IEC 23008-12 is used as one example. HIEF allows one data file to store relevant image data other than main images and thumbnails thereof. For example, still image or moving image data having a depth of 10 bits, which has been encoded using an encoding method conforming to the H. 265 or High Efficiency Video Codec (HEVC) standard, can be stored as the relevant image data.

Hereinafter, it is assumed that HDR signals of the PQ format are recorded as data of main images, and an HIEF data file in which maxDRL related to the main images is recorded in metadata is handled, unless specifically stated otherwise. maxDRL is information indicating the maximum luminance value [nits or cd/m²] of an output dynamic range, or a tone value (signal level) corresponding to the maximum luminance value. The following description will be provided under the assumption that maxDRL indicates a luminance value. Note that although individual explanations will not be provided, in a case where the unit of maxDRL is different from the unit of another value calculated together with maxDRL, calculation is carried out after converting one unit into the other unit to have the values represented in the same unit.

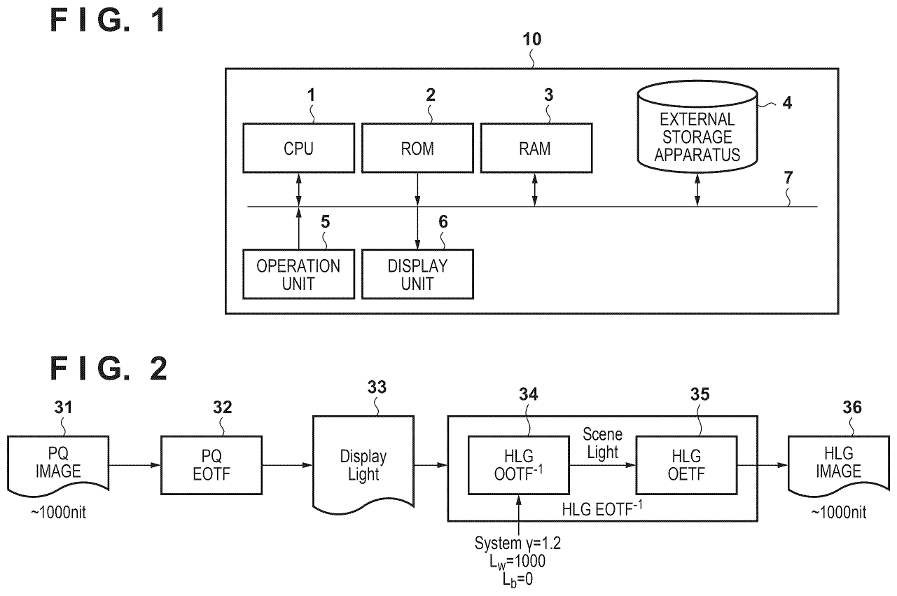

FIG. 1 is a block diagram showing an exemplary functional configuration of an image processing apparatus 10 according to an embodiment. The image processing apparatus 10 includes a CPU 1, a ROM 2, a RAM 3, an external storage apparatus 4, an operation unit 5, a display unit 6, and a system bus 7.

The CPU 1 carries out the operations of the image processing apparatus 10, which will be described below, by loading programs stored in the ROM 2 and the external storage apparatus 4 to the RAM 3 and executing the programs. Note that although FIG. 1 shows one CPU 1, a plurality of CPUs may cooperate in reality.

The ROM 2 is a nonvolatile, electrically rewritable memory. The ROM 2 stores control programs that are necessary for activation of the image processing apparatus 10, such as a BIOS, programs that need not be changed, parameters, and data.

The RAM 3 includes a working area for the CPU 1, a primary storage area for temporarily storing various types of data, a load area for various types of programs, a video memory area for the display unit 6, and so forth.

The external storage apparatus 4 stores basic software (an OS), various types of control programs, various types of application programs executable on the OS, various types of data, and so forth. The external storage apparatus 4 is, for example, a hard disk drive (HDD), a solid-state drive (SSD), a storage apparatus that uses removable media, or the like. The external storage apparatus 4 may be attachable and removable.

The external storage apparatus 4 stores, for example, a plurality of application programs, including the following application programs:
an application program that applies so-called development processing to RAW-format image data in which a pixel has one color component; and
an application program that converts the format of HDR signals from the PQ format to the HLG format.

The operation unit 5 is, for example, one or more input devices operable by a user, such as a keyboard, a mouse, and a touch panel. The CPU 1 detects an operation on the operation unit 5, and executes processing corresponding to the detected operation.

The display unit 6 is, for example, a liquid crystal display (LCD) or an organic EL display. The display unit 6 may be an external apparatus. The display unit 6 displays various types of information via user interfaces of the OS and application programs operating on the image processing apparatus 10.

The above-described functional blocks are connected to one another in a communication-enabled manner via the system bus 7.

FIG. 2 is a model of conversion from the PQ scheme to the HLG scheme, which is described in reference document 1. Hereinafter, HDR signals of the PQ scheme and HDR signals of the HLG scheme will be referred to as PQ images and HLG images, respectively. When a PQ image 31 is generated, the scene luminance thereof is converted into signal values with use of the EOTF⁻¹ of the PQ scheme. Therefore, the signal values are converted into the display luminance (Display Light) by applying the EOTF of the PQ scheme (PQ EOTF) 32 thereto. Note that the EOTF⁻¹ is the inverse function of the electro-optical transfer function (EOTF). The same goes for the opto-optical transfer function (OOTF) and the opto-electronic transfer function (OETF). The opto-optical transfer function (OOTF) is a transfer function that converts the subject luminance (Scene Light) into the display luminance (Display Light).

As the display luminance reflects the intention of production, the display luminance is converted into the scene luminance (Scene Light) by applying the OOTF⁻¹ of the HLG scheme (HLG OOTF⁻¹) 34 thereto. Thereafter, the OETF of the HLG scheme (HLG OETF) 35 is applied, and consequently, an HLG image 36 is obtained. Note that the combination of the HLG OOTF⁻¹ 34 and the HLG OETF 35 is equivalent to the EOTF⁻¹ of the HLG scheme (EOTF⁻¹).

Reference document 1 describes γ=1.2, the maximum display luminance L_{W}=1000 [nit], and the black display luminance L_{B}=0 [nit] as standard parameter values. These parameter values are set in the HLG OOTF⁻¹ 34. According to this conversion method, changes in luminance caused by the conversion can be avoided by bringing the maximum luminance of the PQ image in conformity to the maximum luminance of the HLG image (here, 1000 [nit]).

However, the signal value corresponding to the maximum luminance varies between the original PQ image and the converted HLG image. For example, in a case where the maximum luminance of the PQ image is 650 [nit] and the signal value thereof is 721, the corresponding signal value in the converted HLG image is 955. Therefore, in a case where the signal level corresponding to the maximum luminance related to the PQ image has been recorded as maxDRL, it cannot be used for the converted HLG image.

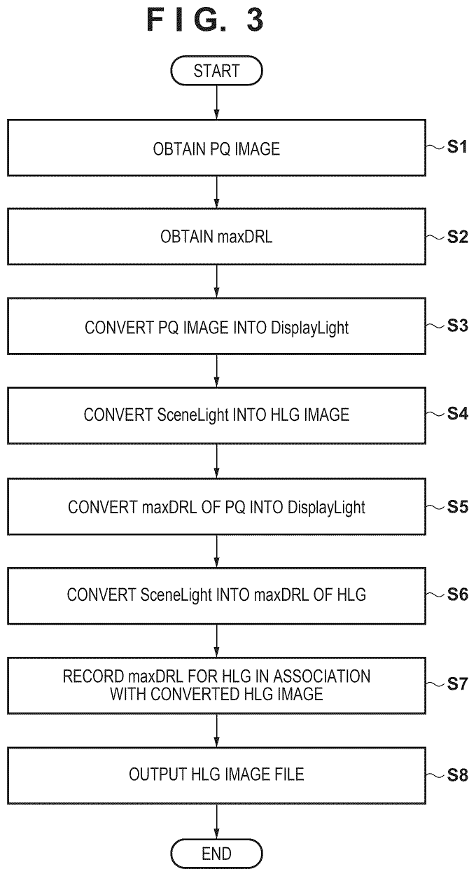

FIG. 3 is a flowchart related to processing of conversion from a PQ image to an HLG image, which is carried out by the CPU 1 executing, for example, a PQ-HLG conversion application program stored in the external storage apparatus 4 in the present embodiment.

It is assumed here that a PQ image of the HEIF format has been generated by an image capturing apparatus, and a subject optical image has been converted into signal values in accordance with the OETF of the image capturing apparatus. It is also assumed that a parameter maxDRL related to the maximum luminance of the PQ image has been recorded as metadata in a data file that stores the PQ image.

Furthermore, information of the transfer functions of the PQ scheme and the HLG scheme (the OOTF, the OETF, the EOTF, and the inverse functions thereof) can be stored in the ROM 2 or the external storage apparatus 4. Note that as long as the PQ EOTF, the PQ OOTF, the HLG OETF, and the HLG OOTF are stored, other transfer functions can be obtained. For example, the PQ OETF can be obtained from the PQ OOTF and the PQ EOTF⁻¹.

In step S1, the CPU 1 obtains a PQ image 31, and reads the same into the RAM 3. It is assumed here that the PQ image 31 is obtained from a HEIF-format data file stored in the external storage apparatus 4; however, it may be obtained from an external apparatus with which communication can be performed via an external interface included in the image processing apparatus 10.

In step S2, the CPU 1 obtains maxDRL related to the PQ image 31 from a data file that stores the PQ image 31, and stores maxDRL into the RAM 3.

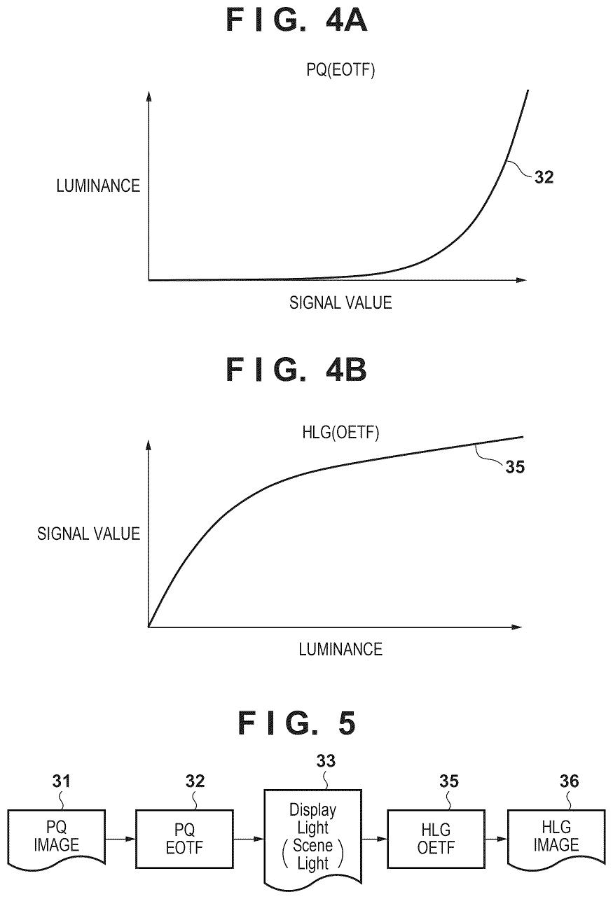

In step S3, the CPU 1 applies the PQ EOTF 32 shown in FIG. 4A to signal values of pixels composing the PQ image 31, thereby converting the signal values of the PQ image 31 into the display luminance (Display Light). As the application of the PQ EOTF 32 eliminates the non-linearity of the OETF that was applied at the time of generation of the PQ image 31, the Display Light represents linear signals.

In step S4, the CPU 1 applies the HLG OOTF⁻¹ to Display Light 33, thereby converting Display Light 33 into Scene Light. Scene Light is signals equivalent to the subject luminance. While the OOTF⁻¹ can be obtained by combining (as a product of) the EOTF⁻¹ and the OETF⁻¹, it may be stored in the ROM 2 or the external storage apparatus 4 in advance. Also, system parameters (γ, L_{W}, and L_{B}) used for the OOTF⁻¹ may be those described above.

Then, the CPU 1 applies the HLG OETF 35 shown in FIG. 4B to Scene Light, thereby converting Scene Light into signal values of the HLG image 36.

Note that in step S4, the HLG OETF 35 may be applied while regarding Display Light 33 as Scene Light, without converting Display Light 33 into Scene Light with use of the OOTF⁻¹. In this case, the HLG image 36 is obtained through a conversion procedure shown in FIG. 5.

In steps S5 and S6, the CPU 1 converts maxDRL of the PQ image into maxDRL of the HLG image by using a method similar to that of steps S3 and S4. Specifically, in step S5, the CPU 1 converts maxDRL of the PQ image obtained in step S2 into a value of Display Light by applying the PQ EOTF 32 thereto.

Then, in step S6, the CPU 1 applies the HLG OOTF⁻¹ to maxDRL that has been converted into the value of Display Light, thereby converting maxDRL into a value of Scene Light. Furthermore, the CPU 1 applies the HLG OETF 35 to maxDRL that has been converted into the value of Scene Light, thereby converting maxDRL into maxDRL of the HLG image 36. At this time also, maxDRL that has been converted into the value of Display Light may be converted into maxDRL of the HLG image 36 by directly applying the HLG OETF 35 thereto.

In step S7, the CPU 1 generates a HEIF-format data file for storing the HLG image 36 obtained in step S4, and includes therein the converted maxDRL (for the HLG image) obtained in step S6 as metadata. Note that the CPU 1 can also include the original maxDRL (for the PG image) in the data file as metadata.

Note that in a case where a highlight threshold applied to the PQ image is defined as a luminance value, the CPU 1 converts this highlight threshold into a highlight threshold for the HLG image 36, similarly to maxDRL. Then, in step S7, the CPU 1 also includes the highlight threshold for the HLG image, as metadata, in the HEIF-format data file for storing the HLG image 36. Note that in a case where a highlight alert amount is defined in place of the highlight threshold applied to the PQ image, the CPU 1 first obtains the highlight threshold, and then converts the same into the highlight threshold for the HLG image.

A highlight alert is a function that allows the user to acknowledge regions with saturated luminance (blown-out highlights) and regions that are mostly blown out within an image. Pixels with values exceeding the highlight threshold are the targets of the highlight alert. Furthermore, the highlight alert amount is equivalent to the difference between maxDRL and the highlight threshold. That is to say, the following relationship is satisfied.

Highlight threshold=maxDRL−highlight alert amount

A highlight alert threshold and a highlight alert amount are both parameters that have been determined on the basis of maxDRL.

For example, in a case where the highlight alert amount ΔPQ is defined as an I value (luminance value) in the ICtCp color space, which is one of perceptually uniform color spaces and which is defined by ITU-R BT.2100, the CPU 1 obtains the highlight alert threshold as follows.

An RGB value (Xr, Xg, Xb) of a certain pixel X is converted into a value in the ICtCp color space, and the obtained I value (luminance value) is expressed as I (X). Furthermore, it is assumed that the highlight alert threshold for RGB values of a PQ HDR image is PQ thrH, and maxHDR of the PQ image is PQ maxHDR. In this case, the following relationship is satisfied.

I(PQ thrH)=I(PQ maxHDR)−ΔPQ formula 2

In this way, the CPU 1 obtains the I value (I (PQ thrH)) of the highlight threshold applied to the PQ image 31 by converting maxDRL related to the PQ image 31 into an I value and subtracting the highlight alert amount therefrom. Then, after converting the I value into a luminance value in the same color space as maxHDR, the CPU 1 converts the luminance value into the highlight threshold for the HLG image 36, similarly to maxHDR.

In step S8, the CPU 1 records the data file of the HLG image in the external storage apparatus 4. Note that although the HLG image and the converted maxDRL and highlight alert threshold are recorded here while being included in the same data file, such recording may not be performed. For example, the CPU 1 may hold the HLG image and the converted maxDRL and highlight alert threshold in the RAM 3 in association with one another, without recording them in the external storage apparatus 4.

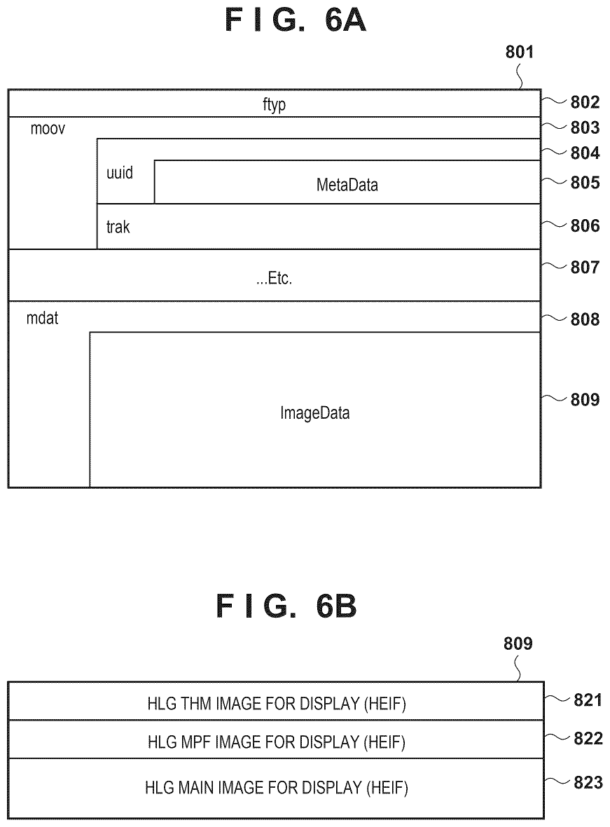

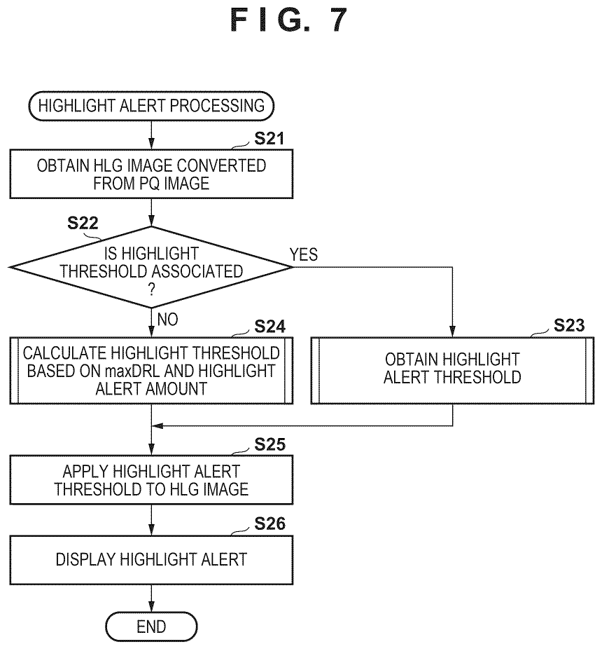

FIG. 6A is a diagram showing an example of a file structure of a HEIF-format data file used for PQ images and HLG images in the present embodiment. ftype 802 is a container (area) for storing header information. MetaData 805 stores metadata, such as maxDRL and the highlight alert threshold. ImageData 809 stores image data.

FIG. 6B is a diagram showing the details of ImageData 809. Various types of image data can be stored in ImageData 809. It is assumed here that ImageData 809 includes a thumbnail area 821, a Multi Picture Format image area 822, and a main image area 823.

As described above, in the present embodiment, when a PQ image is converted into an HLG image, maxDRL and the highlight alert threshold are also converted and associated with the HLG image, similarly to the image.

### Highlight Alert Operations

Next, using a flowchart shown in FIG. 7, a description is given of highlight alert processing for an HLG image converted from a PQ image. The highlight alert processing can be executed with respect to frames of still images or moving images.

In step S21, the CPU 1 obtains an HLG image and reads the same into the RAM 3. It is assumed here that the HLG image is obtained from a HEIF-format data file stored in the external storage apparatus 4; however, it may be obtained from an external apparatus with which communication can be performed via an external interface included in the image processing apparatus 10. It is assumed that the HLG image obtained here has been converted from a PG image, and includes at least maxHDR converted for the HLG image, as described earlier.

In step S22, for example, by referring to metadata in the data file, the CPU 1 determines whether a highlight alert threshold is associated with the obtained HLG image. The CPU 1 executes step S23 if it has been determined that the highlight alert threshold has been associated, and step S24 if it has not been thus determined.

In step S23, the CPU 1 obtains the highlight alert threshold associated with the HLG image, and stores the same into the RAM 3. Note that in a case where the highlight alert threshold associated with the HLG image is a highlight alert threshold corresponding to the original PQ image, the CPU 1 converts the highlight alert threshold into a highlight alert threshold corresponding to the HLG image with use of the method that has been described using FIG. 3, and then stores the converted highlight alert threshold into the RAM 3.

In step S24, the CPU 1 obtains maxDRL associated with the HLG image, and stores the same into the RAM 3. Also, CPU 1 obtains a highlight alert amount from, for example, the ROM 2. Note that the CPU 1 obtains maxDRL and the highlight alert amount for the same HDR format. That is to say, if the highlight alert amount stored in the ROM 2 is for the HLG image, the CPU 1 obtains converted maxDRL. On the other hand, if the highlight alert amount stored in the ROM 2 is for the PQ image, the CPU 1 obtains original maxDRL.

Then, the CPU 1 calculates a highlight alert threshold to be applied to the HLG image from the obtained maxDRL and highlight alert amount. In a case where the highlight alert amount for the HLG image and converted maxDRL have been obtained, the CPU 1 can calculate the highlight alert threshold by subtracting the highlight alert amount from maxDRL. On the other hand, in a case where the highlight alert amount for the PQ image and original maxDRL have been obtained, the CPU 1 can calculate the highlight alert threshold with use of the method that has been described using FIG. 3. The CPU 1 stores the calculated highlight alert threshold into the RAM 3.

In step S25, the CPU 1 applies the highlight alert threshold to the HLG image. The CPU 1 compares, for example, the values of the respective pixels composing the HLG image with the highlight alert threshold, and detects pixels with values exceeding the highlight alert threshold as pixels that are alert targets. When comparing the pixel values with the highlight alert threshold, the CPU 1 converts the format of the pixel values or the highlight alert threshold as necessary so that they are in the same format (e.g., RGB values or luminance values). Note that when the RGB values are compared, pixels with RGB components that all exceed the highlight alert threshold are set as highlight alert targets.

In step S26, the CPU 1 performs highlight alert display. Although there are not particular restrictions on the method of highlight alert display, a specific pattern like a zebra pattern is displayed (constantly or periodically) in such a manner that it is superimposed on regions composed of the pixels that have been detected as the highlight alert targets in step S25 within the original image (the HLG image obtained in step S21). Alternatively, within the original image, the values of the pixels that are the alert targets can be (constantly or periodically) changed to a specific value, or the pixels that are the alert targets can be displayed while blinking. These are merely examples, and it is possible to use any display method in which the pixels that are the alert targets are visually distinguishable from other pixels.

As described above, according to the present embodiment, processing based on original luminance information can be appropriately executed with respect to HDR signals converted from the PQ format into the HLG scheme.

Specifically, highlight alert display similar to that for the original PQ image can be performed with respect to the HLG image converted from the PQ image on the basis of the BT.2408 standard. For example, when the original image is a PQ image with peak luminance of 649 [nit], maxDRL is 721 in 10-bit representation. In a case where conversion into the HLG image has been performed based on the BT.2408 standard, converted maxDRL is 957 in 10-bit representation.

Furthermore, provided that the highlight alert amount for the PQ image is set at 6 in 10-bit representation, the highlight alert threshold for the PQ image is 715 in 10-bit representation. The highlight alert threshold applied to the converted HLG image is 948 in 10-bit representation. As converted maxDRL is 957 in 10-bit representation, the highlight alert amount for the HLG image is 9.

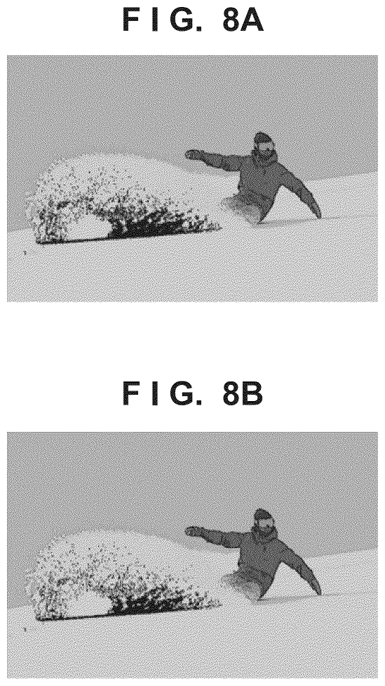

FIG. 8A shows an example of a highlight alert display in a case where the highlight alert threshold for the PQ image has been converted into the highlight alert threshold for the HLG image in accordance with the present embodiment. That is to say, FIG. 8A is the same as a highlight alert display for the original PQ image. In FIG. 8A, pixels that are alert targets are shown as black pixels.

On the other hand, FIG. 8B shows an example of a highlight alert display in which the highlight alert amount for the PQ image is used as is for the converted HLG image with respect to the same original image as FIG. 8A. When conversion according to the present embodiment has been applied, in a case where the highlight alert amount for the PQ image is set at 6 in 10-bit representation, the highlight alert amount for the HLG image is 9. However, if the highlight alert amount of 6 for the original image is used as is, the highlight alert threshold increases, thereby decreasing the number of pixels that are alert targets.

### Second Embodiment

Next, a second embodiment of the disclosure will be described. In the first embodiment, the highlight alert threshold and the highlight alert amount for the converted HLG image are calculated successively with use of formulae based on the BT.2408 standard. In the present embodiment, calculation results are stored in the ROM 2 in advance as a lookup table (LUT).

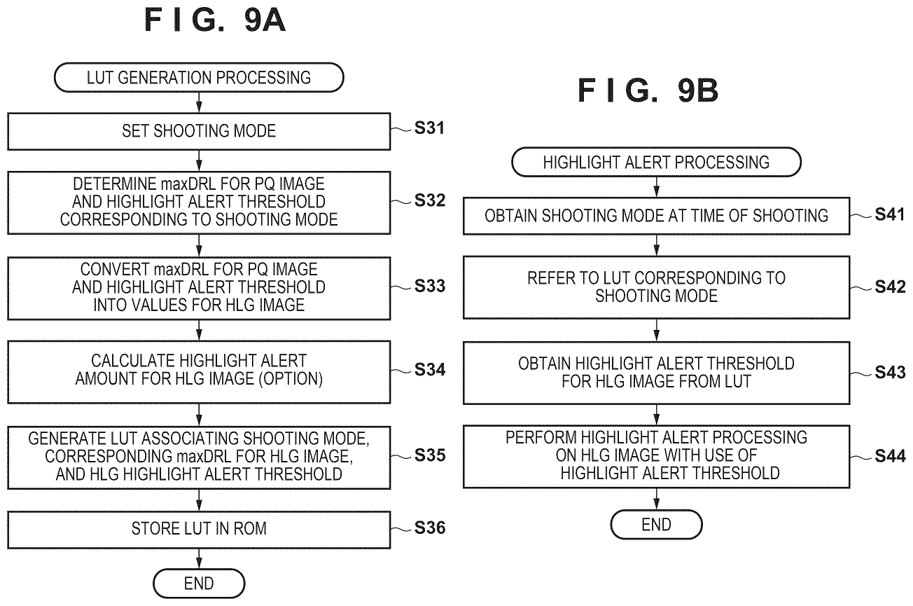

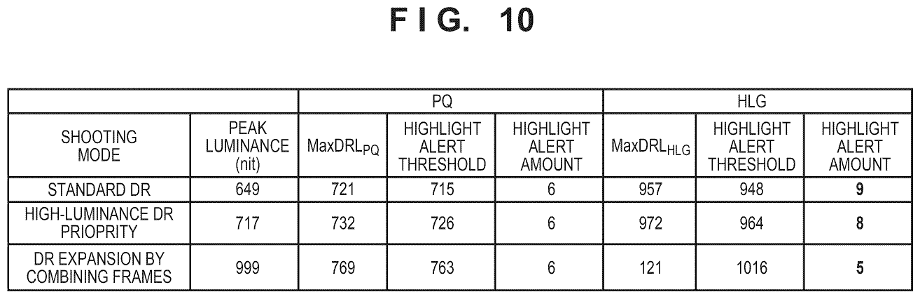

A method of generating a LUT will be described using flowcharts shown in FIGS. 9A and 9B. As stated earlier, as the peak luminance of a PQ image can vary depending on, for example, a shooting mode, the CPU 1 sets a shooting mode in step S31. The shooting mode may be set based on a user setting, or may be set automatically by the CPU 1 using any method.

In step S32, the CPU 1 determines maxDRL and a highlight alert threshold corresponding to the shooting mode. There are not particular restrictions on a determination method; the CPU 1 may obtain maxDRL and a highlight alert threshold that have been stored in the ROM 2 in advance in correspondence with the shooting mode. Alternatively, the CPU 1 may calculate them by applying, for example, predetermined coefficients corresponding to the shooting mode to predetermined reference maxDRL and highlight alert threshold.

In step S33, using the method described in the first embodiment, the CPU 1 converts the maxDRL and the highlight alert threshold determined in step S32 into values for an HLG image.

In step S34 (option), the CPU 1 calculates a highlight alert amount for the HLG image by subtracting the converted highlight alert threshold from the converted maxDRL as necessary.

In step S35, the CPU 1 generates a LUT that stores the maxDRL and the highlight alert threshold (and further the highlight alert amount as necessary) for the HLG image in association with the shooting mode set in step S31. In a case where there are a plurality of settable shooting modes, an LUT that supports the plurality of shooting modes may be generated by repeatedly executing processing of steps S31 to S34 for each shooting mode.

In step S36, the CPU 1 stores the generated LUT into the ROM 2.

FIG. 10 shows an example of the LUT generated through processing of FIG. 9A. This figure shows an example of the LUT that supports three shooting modes (a standard DR mode, a high-luminance DR priority mode, and a mode that expands DR by combining a plurality of frames). The LUT stores maxDRLs, highlight alert thresholds, and highlight alert amounts for the PQ image and the HLG image in association with the shooting modes. All of them are in 10-bit representation. Although a system gamma of 1.2 is expected here, different LUTs may be generated for different system gammas.

A method of referring to the generated LUT will be described using a flowchart shown in FIG. 9B.

In step S41, the CPU 1 obtains, from the operation unit 5 for example, a shooting mode that was set at the time of shooting of the original image (PQ image) related to the HLG image on which highlight alert display is to be performed. The shooting mode may be obtained from another location; for example, it may be obtained from metadata of a data file storing the target image.

In step S42, the CPU 1 reads in a LUT corresponding to the shooting mode obtained in step S41 from the ROM 2 to the RAM 3.

In step S43, the CPU 1 refers to the LUT, and obtains a highlight alert threshold (or obtains maxDRL and a highlight alert amount) corresponding to the HLG image on which highlight alert display is to be performed.

In step S44, the CPU 1 performs highlight alert display on the HLG image, similarly to step S26, with use of the obtained highlight alert threshold (or a highlight alert threshold calculated from the obtained maxDRL and highlight alert amount).

The present embodiment, too, can realize the advantageous effects similar to those of the first embodiment. Furthermore, as parameters necessary for the highlight alert processing (maxDRL and the highlight alert amount, or the highlight alert threshold) are calculated and stored as a LUT in advance, high-speed processing can be realized. This is therefore suitable for use that requires high-speed processing, like in a case where the highlight alert processing is executed with respect to moving images used in live-view display.

### Other Embodiments

The above embodiments have been described in relation to the highlight alert processing as one example of processing that is based on luminance information of a original PQ image. However, the disclosure is also similarly applicable to processing that uses any parameters defined on the basis of luminance information, such as maxDRL, of a original PQ image.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-030636, filed Feb. 29, 2024, which is hereby incorporated by reference herein in its entirety.

What is claimed is:

1. An image processing apparatus that comprises one or more processors, wherein the one or more processors execute a program stored in a memory and thereby perform a method comprising:
obtaining a hybrid log gamma (HLG) image having been converted from a perceptual quantization (PQ) image, wherein the HLG image is a high-dynamic range (HDR) signal conforming to an HLG scheme and the PQ image is an HDR signal conforming to a PQ scheme;
obtaining a parameter that is defined based on information related to a maximum luminance of the PQ image;
converting a value of the parameter into a value conforming to the HLG scheme; and
executing alert processing related to the HLG image with use of the converted value of the parameter.

2. The image processing apparatus according to claim 1, wherein
the parameter is a threshold related to luminance, and a target of the alert processing is a pixel of the HLG image with a luminance value that is identified by the threshold.

3. The image processing apparatus according to claim 1, wherein
in a case where the parameter is a value indicating a difference between the maximum luminance and another parameter, the method further comprises
converting the information related to the maximum luminance into a value conforming to the HLG scheme,
wherein the processing includes calculating a threshold related to luminance with use of the converted value of the parameter and the converted information related to the maximum luminance, and
wherein the target of the alert processing is a pixel of the HLG image with a luminance value that is identified by the threshold.

4. The image processing apparatus according to claim 3, wherein
the calculating the threshold includes calculating, as the threshold, a value by subtracting the converted value of the parameter from the converted information related to the maximum luminance.

5. The image processing apparatus according to claim 1, wherein
the parameter is associated with the HLG image.

6. The image processing apparatus according to claim 1, wherein
the converting converts the value of the parameter by referring to a lookup table stored in advance.

7. The image processing apparatus according to claim 6, wherein
the lookup table includes the converted values of the parameter for respective shooting modes that can be set at a time of shooting of the PQ image.

8. An image processing apparatus that comprises one or more processors, wherein the one or more processors execute a program stored in a memory and thereby perform a method comprising:
converting a perceptual quantization (PQ) image into a hybrid log gamma (HLG) image, wherein the PQ image is an HDR signal conforming to a PQ scheme and the HLG image is a high-dynamic range (HDR) signal conforming to an HLG scheme;
converting a parameter that is defined based on information related to a maximum luminance of the PQ image into a value conforming to the HLG scheme; and
recording the HLG image and the converted value of the parameter in association with each other.

9. The image processing apparatus according to claim 8, wherein
the parameter is a threshold related to luminance.

10. The image processing apparatus according to claim 8, wherein
in a case where the parameter is a value indicating a difference between the maximum luminance and another parameter, the converting further comprises
converting the information related to the maximum luminance into a value conforming to the HLG scheme, and
wherein the recording includes recording the converted information related to the maximum luminance in association with the HLG image.

11. An image processing method, comprising:
obtaining a hybrid log gamma (HLG) image having been converted from a perceptual quantization (PQ) image, wherein the HLG image is a high-dynamic range (HDR) signal conforming to an HLG scheme and the PQ image is an HDR signal conforming to a PQ scheme;
obtaining a parameter that is defined based on information related to a maximum luminance of the PQ image;
converting a value of the parameter into a value conforming to the HLG scheme; and
executing alert processing related to the HLG image with use of the converted value of the parameter.

12. An image processing method, comprising:
converting a perceptual quantization (PQ) image into a hybrid log gamma (HLG) image, wherein the PQ image is an HDR signal conforming to a PQ scheme and the HLG image is a high-dynamic range (HDR) signal conforming to an HLG scheme;
converting a parameter that is defined based on information related to a maximum luminance of the PQ image into a value conforming to the HLG scheme; and
recording the HLG image and the converted value of the parameter in association with each other.

13. A non-transitory computer-readable medium storing a program for causing a computer to perform an image processing method, comprising:
obtaining a hybrid log gamma (HLG) image having been converted from a perceptual quantization (PQ) image, wherein the HLG image is a high-dynamic range (HDR) signal conforming to an HLG scheme and the PQ image is an HDR signal conforming to a PQ scheme;
obtaining a parameter that is defined based on information related to a maximum luminance of the PQ image;
converting a value of the parameter into a value conforming to the HLG scheme; and
executing alert processing related to the HLG image with use of the converted value of the parameter.

14. A non-transitory computer-readable medium storing a program for causing a computer to perform an image processing method, comprising:
converting a perceptual quantization (PQ) image into a hybrid log gamma (HLG) image, wherein the PQ image is an HDR signal conforming to a PQ scheme and the HLG image is a high-dynamic range (HDR) signal conforming to an HLG scheme;
converting a parameter that is defined based on information related to a maximum luminance of the PQ image into a value conforming to the HLG scheme; and
recording the HLG image and the converted value of the parameter in association with each other.
